(19) United States
(12) Patent Application Publication
(10) Pub. No.: US 2025/0194838 A1
(43) Pub. Date: Jun. 19, 2025

(54) SAFE DEVICE AND SAFE SYSTEM

(71) Applicant: Glory Ltd., Himeji-shi (JP)

(72) Inventor: Takato SAIKI, Himeji-shi (JP)

(73) Assignee: Glory Ltd., Himeji-shi (JP)

(21) Appl. No.: 19/063,399

(22) Filed: Feb. 26, 2025

Related U.S. Application Data
(63) Continuation of application No. PCT/JP2023/031212, filed on Aug. 29, 2023.

(30) Foreign Application Priority Data
Aug. 30, 2022 (JP) 2022-136870

(51) Int. Cl. A47G 29/14

(52) U.S. Cl. CPC A47G 29/141; A47G 2029/145; A47G 2029/146; A47G 2029/149

(57) ABSTRACT

A safe device comprises a housing, a first door, a second door, a first operation interface and a second operating interface. The housing is installed in contact with a wall of a facility, the housing and the wall separating a first area of the facility from a second area of the facility. The first door is on a first surface of the housing and facing the first area, the second door is on a second surface of the housing and facing the second area. The first operation interface faces the first area and operated to input first information related to an item inserted into the safe device through the first door. The second operation interface faces the second area and operated to input second information related to an item to be removed from the safe device through the second door.

### CROSS-REFERENCE TO RELATED APPLICATIONS

The present application is a continuation of and claims priority to PCT/JP2023/031212, filed in Japan on Aug. 29, 2023, which claims priority to JP 2022-136870, filed in Japan on Aug. 30, 2022. The entire contents of both are incorporated by reference in their entirety.

### TECHNICAL FIELD

The present disclosure relates to a safe device and a safe system.

### BACKGROUND

Conventionally, a storage shelf may be included in inner boxes of a safe deposit box device. Storage spaces for inner boxes may be formed in multiple rows and multiple levels, and each storage space may include ceiling materials, floor materials, left and right side wall materials arranged vertically and horizontally. A locked opening and closing door may be attached to a front side to allow the inner boxes to be manually loaded and unloaded from the front side, and a rear side may be fully open to allow the inner boxes to be automatically loaded and unloaded from the rear side by a loading and unloading device.

### SUMMARY

In accordance with the present disclosure, a safe device comprises a housing installed in contact with a wall of a facility, the housing and the wall separating a first area of the facility from a second area of the facility; a first door on a first surface of the housing and facing the first area; a second door on a second surface of the housing and facing the second area; a first operation interface facing the first area and operated to input first information related to an item inserted into the safe device through the first door; and a second operation interface facing the second area and operated to input second information related to an item to be removed from the safe device through the second door.

### BRIEF DESCRIPTION OF THE DRAWINGS

FIG. 1 illustrates an overview of a safe device according to an embodiment.

FIG. 2 illustrates a perspective view of an external configuration of a safe device.

FIG. 3 illustrates an example of the external configuration of the safe device when a small door of a locking/unlocking operation unit is open.

FIG. 4 illustrates another perspective view of the external configuration of the safe device.

FIG. 5 illustrates a functional configuration of the safe device.

FIG. 6 illustrates storage information stored in a storage unit of the safe device.

FIG. 7 illustrates operation information stored in a storage unit of the safe device.

FIG. 8 illustrates a menu screen displayed when there is no item stored in the safe device.

FIG. 9 illustrates a menu screen displayed when there is an item stored in the safe device.

FIG. 10 illustrates a storage screen displayed on the safe device when a storage button is pressed on the menu screen.

FIG. 11 illustrates a flowchart of an operation of the safe device when a storage button is pressed on the menu screen.

FIG. 12 illustrates a storage correction screen displayed on the safe device when a storage correction button is pressed on the menu screen.

FIG. 13 illustrates a flowchart of an operation of the safe device when a storage correction button is pressed on the menu screen.

FIG. 14 illustrates a removal screen displayed on the safe device when a removal button is pressed on the menu screen.

FIG. 15 illustrates a withdrawal correction screen displayed on the device when a withdrawal correction button is pressed on the withdrawal screen.

FIGS. 16-1 and 16-2 illustrate a flowchart of an operation of the safe device when a removal button is pressed on the menu screen.

FIG. 17 illustrates a configuration of a safe system according to an embodiment.

### DETAILED DESCRIPTION

The inventors of the present disclosure have recognized that with conventional systems, in order to provide a safe device in which articles stored from one side of an ATM corner side or a backyard side of a financial institution are simply taken out from the other side, it is difficult or impossible to input information on articles stored from one side and information on articles taken out from the other side.

The inventors have developed the technology of the present disclosure to enable input of information regarding items to be stored from one of the ATM corner side and the backyard side of a financial institution, and information regarding items to be removed from the other side.

In accordance with the present disclosure, a safe device may comprise a first door provided on a first side, which is one of the ATM corner side and the backyard side of a financial institution through a wall; a second door provided on a second side, which is the other side of the ATM corner side and the backyard side; a first operation unit provided on the first side and operated to input first information relating to an item to be stored through the first door; a second operation unit provided on the second side and operated to input second information relating to an item to be removed from the second door; and a housing including the first door, the second door, the first operation unit, and the second operation unit, and which is installed against the wall to divide the ATM corner side and the backyard side together with the wall.

The second operation unit may be operated to input, as the second information, consistency determination information indicating whether the first information and the item to be removed from the second door are consistent. In this case, the second operation unit may be operated to input consistency information indicating that the first information and the item to be removed from the second door are consistent as consistency determination information.

In this case, the second operation unit may be operated to input inconsistency information indicating that the first information and the item to be removed from the second door are not consistent as consistency determination information. In this case, the second operation unit may be operated to input information after correcting the first information so as to match the item to be removed from the second door as mismatch information. The safe device may further include a notification unit that notifies the user of information that inconsistency information has been input by operating the second operation unit.

The safe device may further include a determination unit that determines whether or not the first information and the second information are consistent. In this case, the safe device may further include a notification unit that notifies the user when the determination section determines that the first information and the second information are not consistent. The first operating section may be operated to input information after correcting the first information so as to match the item stored through the first door. The safe device may further include an output unit provided on one of the first side and the second side for outputting information that the operation unit opposite to the one side of the first operation unit and the second operation unit is being operated. The safe device may further include an output unit provided on one of the first side and the second side for outputting information that the door opposite to one of the first door and the second door is open.

The safe device may further include a first imaging unit provided on the first side, and a first memory unit that stores an image of the user's face captured by the first imaging unit in association with the operation content of the first operation unit by the user. The safe device may further include a second imaging unit provided on the second side, and a second memory unit that stores the face image of the user captured by the second imaging unit in association with the operation content of the second operation unit by the user. The safe device may further include a printing unit that is provided on the ATM corner side of the first side or the second side and prints operation information of the operation unit on the ATM corner side of the first operation unit or the second operation unit.

The safe device may further include a first locking/unlocking unit that locks and unlocks the first door, a second locking/unlocking unit that locks and unlocks the second door, a first unlocking operation unit that is operated to electrically perform unlocking by the first locking/unlocking unit, and a second unlocking operation unit that is operated to electrically perform unlocking by the second locking/unlocking unit. In this case, the safe device may further include a first emergency unlocking operation unit operated to perform unlocking by the first locking/unlocking unit through mechanical operation in an emergency, a second emergency unlocking operation unit operated to perform unlocking by the second locking/unlocking unit through mechanical operation in an emergency, and a third emergency unlocking operation unit operated to perform unlocking by the ATM corner locking/unlocking unit, of the first and second locking/unlocking units, through a key input signal in an emergency. The safe device may further include a first emergency unlocking operation unit that is operated to perform unlocking by the first locking/unlocking unit through mechanical operation in an emergency, a second emergency unlocking operation unit that is operated to perform unlocking by the second locking/unlocking unit through mechanical operation in an emergency, and a small door that hides the emergency unlocking operation unit on the ATM corner side of the first emergency unlocking operation unit and the second emergency unlocking operation unit. The first locking/unlocking unit and the second locking/unlocking unit may operate exclusively with respect to each other, and the first door and the second door may operate in such a way that when one is open, the other cannot be opened.

In accordance with the present disclosure, a safe system may include a safe device including a first door provided on a first side, which is one of the ATM corner side and the backyard side of a financial institution through a wall, and a second door provided on a second side, which is the other side of the ATM corner side and the backyard side; a first operation unit operated to input first information related to an item to be stored through the first door; a second operation unit operated to input second information related to an item to be removed from the second door; and a housing including the first door, the second door, the first operation unit, and the second operation unit, and which is installed against the wall to divide the ATM corner side and the backyard side together with the wall.

Hereinafter, embodiments of the present disclosure will be described in detail with reference to the accompanying drawings.

Financial institutions entrust important items to transportation companies every day by mail, for collection and delivery between branches and centers, for example. Since the items collected and delivered include checks that need to be sent on the same day, mail typically travels to each branch at least twice a day. However, as financial institutions transition to use of electronic checks, same-day delivery of mail-order items will no longer be necessary, and financial institutions may consider reducing a number of mail-order deliveries and the amount of labor required. Currently, items are collected and delivered face-to-face, but if safe devices could be used to enable non-face-to-face delivery, further efficiency improvements could be expected.

On the other hand, some financial institutions are exploring ways to utilize the spaces that have become vacant when old ATMs (Automatic Teller Machines) are removed (hereinafter referred to as “vacant ATM spaces”), as a number of ATMs installed is decreasing.

Therefore, in some embodiments, a safe device used for delivering and receiving articles may be installed in an empty space of an ATM where the safe device can be safely operated by both a financial institution and a security company.

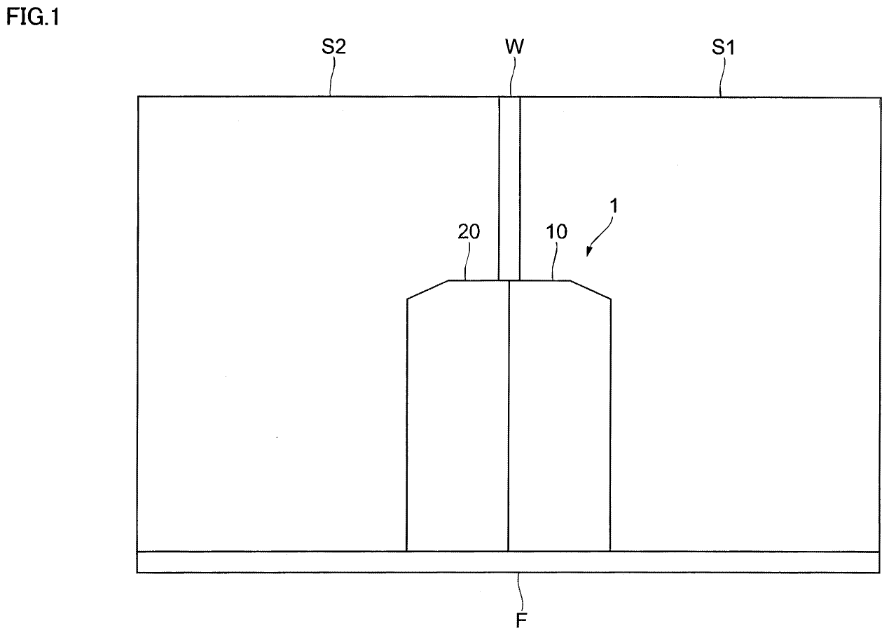

The following discussion of FIGS. 1-17 describes a case where the safe device is provided at a bank. In particular, the safe device may be installed between an inside of a bank and an outside of a bank. The outside of the bank may face, for example, a road. However, the safe device may instead be provided at a retail store or other institution, and may be positioned between a retail staff area and a customer area. Thus, a front of the safe device may be accessible to the customer area and a back of the safe device is accessible to the retail staff area.

FIG. 1 is a diagram showing an outline of a safe device 1. As shown in FIG. 1, the safe device 1 is installed in an empty space of the ATM between a wall W and a floor F that separates an ATM corner S1 from a backyard S2. Therefore, the safe device 1 has a housing size that can fit into the available space of the ATM. In other words, the ATM corner S1 side and the backyard S2 side are on either side of the wall W, and the housing of the safe device 1 is installed adjacent to the wall W, thereby dividing the ATM corner S1 side and the backyard S2 side together with the wall W. Here, the ATM corner S1 refers to a space where general customers can enter to operate the ATM from the front. The ATM corner S1 is also called an automatic transaction machine corner or a CD (Cash Dispenser) corner. The backyard S2 is a space where bank employees operate the ATM from the rear and is off-limits to general customers. The backyard may be a space for the bank employee or the retail staff.

In this state, the safe device 1 is used to receive and deliver articles delivered by a security company to a bank. That is, first, a security guard of the security company stores the article to be delivered in the safe device 1 on the ATM corner S1 side. Thereafter, the bank employee takes out the delivered item from the safe device 1 on the backyard S2 side.

The safe device 1 is also used for receiving and delivering goods that are collected by a security transport company from a bank. That is, first, a bank employee stores the collected goods in the safe device 1 on the backyard S2 side. Thereafter, the security guard of the security company takes out the articles to be collected from the safe device 1 at the ATM corner S1 side.

In some cases, a bank employee may operate the safe device 1 at the ATM corner S1 side, but in the following description, it is assumed that only the security guard operates the safe device 1 at the ATM corner S1.

As shown in FIG. 1, the safe device 1 has an ATM corner side housing 10 on the ATM corner S1 side, and a backyard side housing 20 on the backyard S2 side. However, in order to enable the delivery and receipt of the above-mentioned items, the internal space of the safe device 1 is not partitioned between the ATM corner side housing 10 and the backyard side housing 20, but is integrated. This internal space is fireproof and theft-proof. In an exemplary implementation, a customer may access the safe device 1 in ATM corner S1 side while a bank employee or security may access safe device 1 in backyard S2 side.

### (External Configuration of Safe Device)

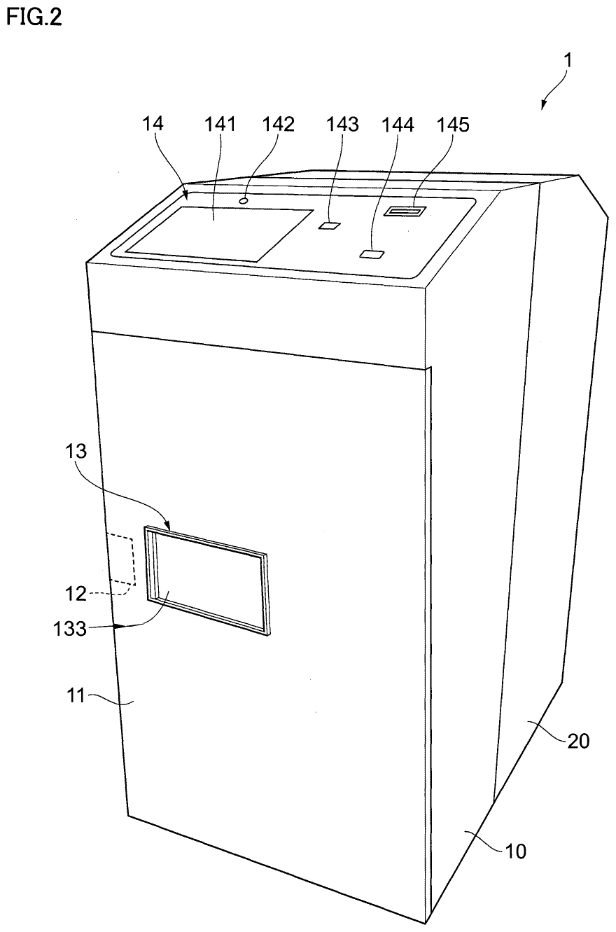

FIG. 2 is a perspective view showing an external configuration of safe device 1. In particular, FIG. 2 shows the external configuration of the safe device 1 as viewed from the ATM corner side S2, and the components of the ATM corner side housing 10 are shown.

As shown FIG. 2, the ATM corner side housing 10 includes a door 11, a locking/unlocking mechanism 12, a locking/unlocking operation unit 13, and an operation terminal 14.

The door 11 is opened and closed when a security officer stores or retrieves an article. When the security officer stores the article on the ATM corner side, the door 11 is an example of a first door provided on the first side, which is the ATM corner side. Furthermore, when the security officer retrieves an article on the ATM corner side, the door 11 is an example of a second door provided on the second side, which is the ATM corner side.

The locking/unlocking mechanism 12 locks and unlocks the door 11. When the security officer stores the item at the ATM corner side, the locking/unlocking mechanism 12 is an example of a first locking/unlocking unit that locks and unlocks the first door. When the security officer retrieves an article at the ATM corner side, the locking/unlocking mechanism 12 is an example of a second locking/unlocking unit that locks and unlocks the second door.

The locking/unlocking mechanism 12 may be controlled so as not to unlock the door 11 when a door 21 (described later) on the backyard side is unlocked. In other words, the locking/unlocking mechanism 12 operates exclusively with the locking/unlocking mechanism 22 (described later), and may operate in such a way that when the door 21 (described later) is open, the door 11 cannot be opened.

The locking/unlocking operation unit 13 is operated by a security guard so that the locking/unlocking mechanism 12 locks and unlocks the door 11 when storing items in an emergency such as a power outage.

As described below, the locking/unlocking operation unit 13 includes a key operation unit 131, a numeric keypad 132, and a small door 133, although only the small door 133 is visible in FIG. 2.

The operation terminal 14 is a terminal used by a security officer to operate the safe device 1.

The operation terminal 14 includes a display operation unit 141, a camera 142, a light-emitting unit 143, a reading unit 144, and a printer 145.

The display operation unit 141 is, for example, a touch panel display, which accepts information input by the user and displays information to be presented to the user.

Specifically, the display operation unit 141 is operated by a security guard so that the locking/unlocking mechanism 12 locks and unlocks the door 11 during normal storage of items when there is no power outage or the like. When the security officer stores the item at the ATM corner side, the display operation unit 141 is an example of a first unlocking operation unit that is operated to electrically perform unlocking by the first locking/unlocking unit.

In addition, when the security officer inputs storage information regarding the items to be stored when storing the items, the display operation unit 141 accepts this storage information. Here, the storage information may be any information related to the items to be stored, for example, the name and number of items. In addition, if the storage information that the security officer entered when storing the items does not correctly represent the name and number of the items actually stored, the security officer can input storage correction information to correct the storage information, and in that case, the display operation unit 141 will accept this storage correction information. Here, the storage correction information may be any information that indicates how to correct the storage information, and may be, for example, the corrected item name and number. When a security guard stores items on the ATM corner side, the storage information is an example of first information regarding the items stored through the first door, and the display operation unit 141 is an example of a first operation unit that is provided on the first side and is operated to input the first information. The storage correction information is an example of information after the first information has been corrected to match the items stored through the first door, and the display operation unit 141 is an example of a first operation unit that is operated to input the information after the first information has been corrected.

On the other hand, the display operation unit 141 is operated by a security officer so that the locking/unlocking mechanism 12 locks and unlocks the door 11 when retrieving goods during normal times when there is no power outage or the like. When the security officer retrieves an article at the ATM corner side, the display operation unit 141 is an example of a second unlocking operation unit that is operated to electrically perform unlocking by the second locking/unlocking unit.

In addition, when the security officer inputs removal information regarding the item to be removed when removing the item, the display operation unit 141 accepts this removal information. Here, the removal information may be any information regarding the item to be removed, but for example, it may be information resulting from a security officer actually removing the item that the bank employee had stored and determining whether the storage information entered by the bank employee when storing the item is correct. One such piece of information may be information indicating that the storage information entered by the bank clerk when storing the item is correct. On the other hand, such information may be information indicating that the storage information entered by the bank clerk when storing the item is incorrect. The information indicating that the storage information is incorrect may be removal correction information for correcting the storage information when an article is removed. When a security guard removes an item at the ATM corner side, the removal information is an example of second information regarding the item to be removed from the second door, and the display operation unit 141 is an example of a second operation unit that is provided on the second side and is operated to input the second information. The information resulting from judging whether the storage information is correct is an example of consistency judgment information indicating whether the first information and the items to be removed from the second door are consistent, and the display operation unit 141 is an example of a second operation unit that is operated to input the consistency judgment information as second information. The information that the storage information is correct is an example of consistency information indicating that the first information and the items to be removed from the second door are consistent, and the display operation unit 141 is an example of a second operation unit that is operated to input the consistency information as consistency judgment information. The information indicating that the storage information is incorrect is an example of inconsistency information indicating that the first information and the items to be removed from the second door are not consistent, and the display operation unit 141 is an example of a second operation unit that is operated to input the inconsistency information as consistency judgment information. The removal correction information is an example of information after the first information has been corrected to match the item to be removed from the second door, and the display operation unit 141 is an example of a second operation unit that is operated to input the information after the first information has been corrected as inconsistent information.

The camera 142 captures an image of the security officer operating the display operation unit 141. In particular, the camera 142 is directed toward a position where the face of the security guard operating the display operation unit 141 is present, and captures an image of the face of the security guard. The captured image is then recorded in the safe device 1, as will be described later. When the security officer stores the item on the ATM corner side, the camera 142 is an example of a first imaging unit provided on the first side. When the security officer removes an article from the ATM corner side, the camera 142 is an example of a second imaging unit provided on the second side.

When an article is stored in the safe device 1, the light-emitting unit 143 notifies the ATM corner side by emitting light to that effect. The light-emitting unit 143 may be realized by, for example, a lamp, but may be realized by any device that emits light. Incidentally, the information provided by the light-emitting unit 143 may be provided by the display operation unit 141 instead.

When a display operation unit 241 (described later) on the backyard side is operated, the light-emitting unit 143 may notify the ATM corner side of that fact by emitting light. Alternatively, the safe device 1 may notify the user that the display operation unit 241 on the backyard side is being operated by a means other than light emission, such as sound. When the security officer stores the item at the ATM corner side, the light-emitting unit 143 is an example of an output unit that is provided on the first side and outputs information that the second operation unit is being operated. In addition, when the security officer removes an item at the ATM corner side, the light-emitting unit 143 is provided on the second side and is an example of an output unit that outputs information that the first operation unit is being operated.

When a door 21 (described later) on the backyard side is open, the light-emitting unit 143 may emit light to notify the ATM corner of this fact. Alternatively, the safe device 1 may notify the user that the door 21 on the backyard side is open by means other than light emission, such as sound. When the guard stores the item at the ATM corner side, the light-emitting unit 143 is an example of an output unit that is provided on the first side and outputs information that the second door is open. Furthermore, when the security officer removes an article from the ATM corner side, the light-emitting unit 143 is provided on the second side and is an example of an output unit that outputs information that the first door is open.

When an error occurs in the safe device 1, the light-emitting unit 143 may emit light to notify the ATM corner of the occurrence of the error.

When the printer 145 runs out of paper, the light-emitting unit 143 may emit light to notify the ATM corner of that fact.

When any other state change occurs in the safe device 1, the light-emitting unit 143 may notify the ATM corner side of the change by emitting light.

One light-emitting unit 143 is adapted to indicate a plurality of states of the safe device 1. This can be realized, for example, by associating a light emitting pattern with each of a plurality of states and causing one light-emitting unit 143 to emit light in the light emitting pattern corresponding to the state to be notified. However, the present disclosure is not limited to this, and multiple light-emitting units 143 may indicate multiple states of the safe device 1. This can be realized, for example, by associating a light-emitting unit 143 with each of a plurality of states and illuminating the light-emitting unit 143 that corresponds to the state to be notified.

The reading unit 144 reads information from an integrated circuit (IC) card when the IC card is held over the reader 144. Alternatively, the reading unit 144 may read information from a smartphone or the like equipped with a FELICA (registered trademark) function when the smartphone or the like is held up. The information thus read is used to authenticate the security officer when he logs in. However, authentication at the time of login may be performed using biometric information read by a biometric information reading unit, or may be performed using an ID and password input from the display operation unit 141.

The printer 145 prints a copy of the processing of the safe device 1 on paper such as roll paper. The paper printed by the printer 145 is discharged, for example, to the front of the safe device 1. The printer 145 is provided on the ATM corner side and is an example of a printing unit that prints out the operation contents of the operation unit on the ATM corner side.

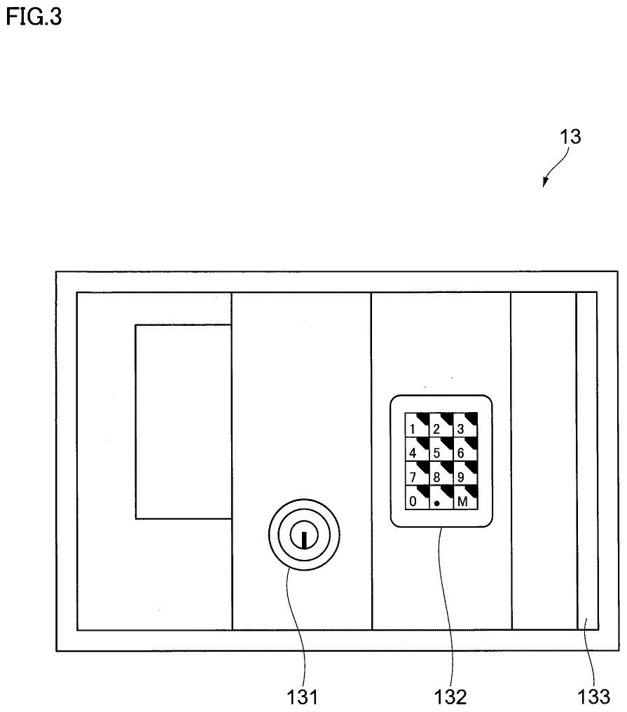

FIG. 3 is a diagram showing an example of the external configuration when the small door 133 of the locking/unlocking operation unit 13 of the safe device 1 is open.

As shown in FIG. 3, the locking/unlocking operation unit 13 includes a key operation unit 131, a numeric keypad 132, and a small door 133.

In the event of an emergency such as a power outage, the key operation unit 131 locks or unlocks the locking/unlocking mechanism 12 by inserting a physical key and operating it. When a security officer stores items at the ATM corner side, the key operation unit 131 is an example of a first emergency unlocking operation unit that is operated to perform unlocking by the first locking/unlocking unit through mechanical operation in an emergency. In addition, when a security officer retrieves an item at the ATM corner side, the key operation unit 131 is an example of a second emergency unlocking operation unit that is operated to perform unlocking by the second locking/unlocking unit through mechanical operation in an emergency.

The numeric keypad 132 is provided for locking and unlocking the locking/unlocking mechanism 12 without using a physical key in an emergency such as a power outage. The security officer can unlock the locking/unlocking mechanism 12 by inputting a password from the numeric keypad 132. The numeric keypad 132 may be powered by a battery, for example, so that it can operate even in an emergency such as a power outage. If only the key operation unit 131 is provided, the delivery officer will always have to visit multiple branches to collect and deliver goods, and will therefore need to carry physical keys for multiple safe devices 1 with him at all times in case of an emergency. Therefore, a numeric keypad 132 is provided so that the user does not need to always carry physical keys for a plurality of safe devices 1. The password entered into the numeric keypad 132 may be a password that can only be used for a certain period of time, such as a one-day password or a one-time password. The numeric keypad 132 is an example of a third emergency unlocking operation unit that is operated in an emergency to unlock the door using a locking/unlocking unit on the ATM corner side by a key input signal.

The small door 133 hides the key operation unit 131 and the numeric keypad 132 so that the safe device 1 installed in the empty space of the ATM does not attract the interest of general customers. The small door 133 is an example of a small door that hides the emergency unlocking operation unit on the ATM corner side.

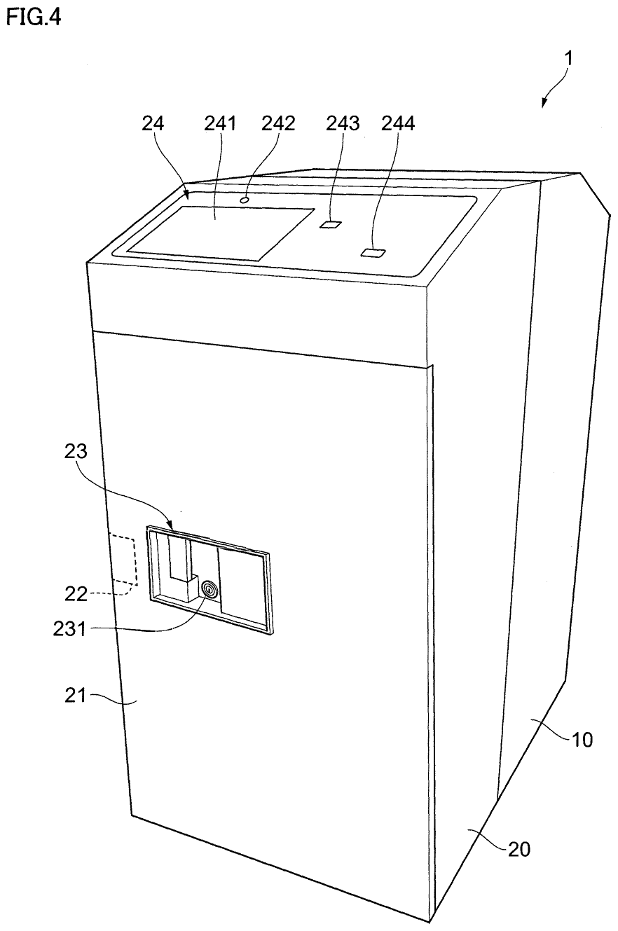

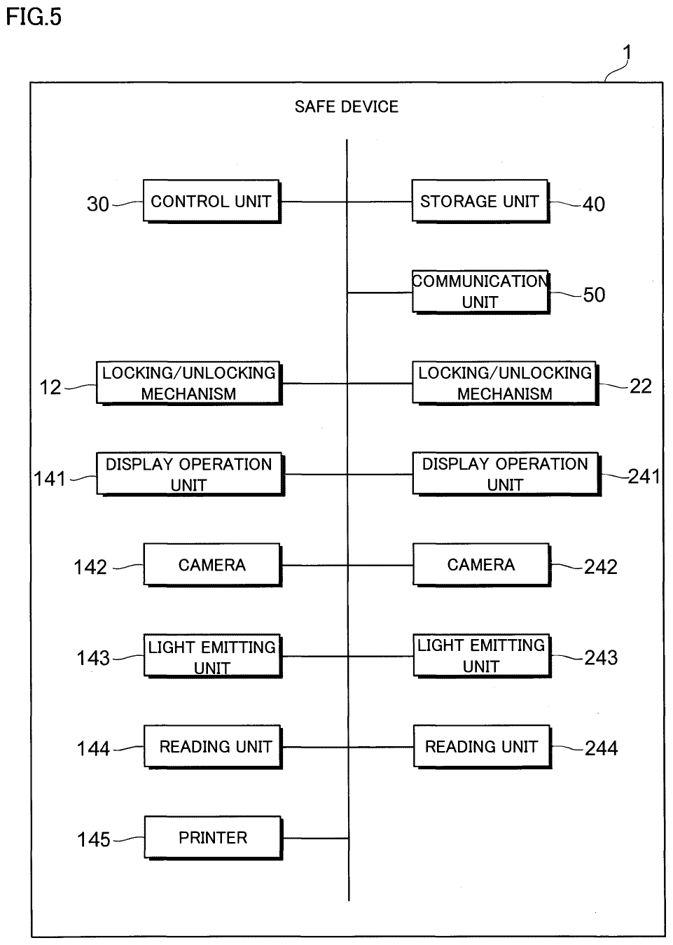

FIG. 4 is a perspective view showing an example of the external configuration of the safe device 1. In particular, FIG. 4 shows the external configuration of the safe device 1 as viewed from the backyard side. Therefore, components of the backyard side housing 20 are shown in FIG. 4.

As shown in FIG. 4, the backyard side housing 20 includes a door 21, a locking/unlocking mechanism 22, a locking/unlocking operation mechanism 23, and an operation terminal 24.

The door 21 is opened and closed when a bank employee puts or takes out an item. When a bank employee stores items on the backyard side, door 21 is an example of a first door provided on the first side, which is the backyard side. In addition, when a bank employee takes out an item on the backyard side, door 21 is an example of a second door provided on the second side, which is the backyard side.

The locking/unlocking mechanism 22 locks and unlocks the door 21. When a bank employee stores items in the backyard, the locking/unlocking mechanism 22 is an example of a first locking/unlocking unit that locks and unlocks the first door. In addition, when a bank employee takes out an item in the backyard, the locking/unlocking mechanism 22 is an example of a second locking/unlocking unit that locks and unlocks the second door.

The locking/unlocking mechanism 22 may be controlled so as not to unlock the door 21 when the door 11 on the ATM corner side is unlocked. In other words, the locking/unlocking mechanism 22 operates exclusively with the locking/unlocking mechanism 12, and may operate in such a way that when the door 11 is open, the door 21 cannot be opened.

The locking/unlocking operation unit 23 is operated by a bank clerk so that the locking/unlocking mechanism 22 locks and unlocks the door 21 when storing items in an emergency such as a power outage.

The locking/unlocking operation unit 23 includes a key operation unit 231.

In the event of an emergency such as a power outage, the key operation unit 231 locks or unlocks the locking/unlocking mechanism 22 by inserting a physical key and operating it. When a bank employee stores items in the backyard, the key operation unit 231 is an example of a first emergency unlocking operation unit that is operated to mechanically unlock the first locking/unlocking unit in an emergency. In addition, when a bank employee retrieves an item in the backyard, the key operation unit 231 is an example of a second emergency unlocking operation unit that is operated to perform unlocking by the second locking/unlocking unit through mechanical operation in an emergency.

Furthermore, there is no numeric keypad on the backyard side. This is because the only physical key used by a bank employee is the physical key for the safe device 1 of his/her own branch, and there is no need for the employee to always carry physical keys for multiple safe devices 1 in case of an emergency.

There is also no small door on the backyard side. This is because general customers do not enter the backyard, and there is no reason to not want general customers to be interested in it.

The operation terminal 24 is a terminal used by a bank clerk when operating the safe device 1.

The operation terminal 24 includes a display operation unit 241, a camera 242, a light-emitting unit 243, and a reading unit 244.

The display operation unit 241 is, for example, a touch panel display, which accepts information input by the user and displays information to be presented to the user.

Specifically, the display operation unit 241 is operated by a bank clerk so that the locking/unlocking mechanism 22 locks and unlocks the door 21 during normal storage of items when there is no power outage or the like. When a bank employee stores items in the backyard, the display operation unit 241 is an example of a first unlocking operation unit that is operated to electrically perform unlocking by the first locking/unlocking unit.

In addition, when a bank clerk inputs storage information regarding the items to be stored when storing the items, the display operation unit 241 accepts this storage information. Here, the storage information may be any information related to the items to be stored, for example, the name and number of items. In addition, if the storage information that the clerk entered when storing the items does not correctly represent the name and number of the items actually stored, the clerk can input storage correction information to correct the storage information, in which case the display operation unit 241 will accept this storage correction information. Here, the storage correction information may be any information that indicates how to correct the storage information, and may be, for example, the corrected item name and number. When a bank employee stores items in the backyard, the storage information is an example of first information regarding the items stored through the first door, and the display operation unit 241 is an example of a first operation unit that is provided on the first side and is operated to input the first information. The storage correction information is an example of information after the first information has been corrected to match the items stored through the first door, and the display operation unit 241 is an example of a first operation unit that is operated to input the information after the first information has been corrected.

On the other hand, the display operation unit 241 is operated by a bank clerk so that the locking/unlocking mechanism 22 locks and unlocks the door 21 when removing items during normal times when there is no power outage or the like. When a bank clerk retrieves an item in the backyard, the display operation unit 241 is an example of a second unlocking operation unit that is operated to electrically perform unlocking by the second locking/unlocking unit.

In addition, when a bank clerk inputs removal information regarding the item to be removed when removing the item, the display operation unit 241 accepts this removal information. Here, the removal information may be any information regarding the items to be removed, but for example, it may be information resulting from a bank employee actually removing the items stored by the security guard and judging whether the storage information entered by the security guard when storing the items is correct. One such piece of information may be information indicating that the storage information entered by the security officer when storing the item is correct. Alternatively, such information may be information indicating that the storage information entered by the security officer when storing the item is incorrect. The information indicating that the storage information is incorrect may be removal correction information for correcting the storage information when an article is removed. When a bank employee removes an item on the backyard side, the removal information is an example of second information regarding the item to be removed through the second door, and the display operation unit 241 is an example of a second operation unit that is provided on the second side and is operated to input the second information. The information resulting from judging whether the storage information is correct is an example of consistency judgment information indicating whether the first information and the items to be removed from the second door are consistent, and the display operation unit 241 is an example of a second operation unit that is operated to input the consistency judgment information as the second information. The information that the storage information is correct is an example of consistency information indicating that the first information and the items to be removed from the second door are consistent, and the display operation unit 241 is an example of a second operation unit that is operated to input the consistency information as consistency judgment information. The information indicating that the storage information is incorrect is an example of inconsistency information indicating that the first information and the items to be removed from the second door are not consistent, and the display operation unit 241 is an example of a second operation unit that is operated to input the inconsistency information as consistency judgment information. The removal correction information is an example of information after the first information has been corrected to match the item to be removed from the second door, and the display operation unit 241 is an example of a second operation unit that is operated to input the information after the first information has been corrected as inconsistent information.

The camera 242 captures an image of a bank clerk operating the display operation unit 241. In particular, the camera 242 is directed toward a position where the face of the bank clerk operating the display operation unit 241 is present, and captures an image of the bank clerk's face. The captured image is then recorded in the safe device 1, as will be described later. When a bank employee stores an item on the backyard side, camera 242 is an example of a first imaging unit provided on the first side. When a bank employee takes out an item on the backyard side, camera 242 is an example of a second imaging unit provided on the second side.

When an article is stored in the safe device 1, the light-emitting unit 243 notifies the backyard side by emitting light to that effect. The light-emitting unit 243 may be realized by, for example, a lamp, but may be realized by any device that emits light. Incidentally, the information provided by the light-emitting unit 243 may be provided by the display operation unit 241 instead.

When the display/operation unit 141 on the ATM corner side is being operated, the light-emitting unit 243 may notify the backyard side of that fact by emitting light. Alternatively, the safe device 1 may notify the user that the display operation unit 141 on the ATM corner side is being operated by a means other than light emission, such as sound. When a bank employee stores items in the backyard, the light-emitting unit 243 is provided on the first side and is an example of an output unit that outputs information that the second operation unit is being operated. In addition, when a bank employee takes out an item on the backyard side, the light-emitting unit 243 is provided on the second side and is an example of an output unit that outputs information that the first operation unit is being operated.

When the door 11 on the ATM corner side is open, the light-emitting unit 243 may emit light to notify the backyard side of that fact. Alternatively, the safe device 1 may notify the user that the door 11 on the ATM corner side is open by means other than light emission, such as sound. When a bank employee stores items on the backyard side, the light-emitting unit 243 is an example of an output unit that is provided on the first side and outputs information that the second door is open. In addition, when a bank employee takes out an item on the backyard side, the light-emitting unit 243 is provided on the second side and is an example of an output unit that outputs information that the first door is open.

When an error occurs in the safe device 1, the light-emitting unit 243 may notify the backyard side of the occurrence of the error by emitting light.

When the printer 145 at the ATM corner runs out of paper, the light-emitting unit 243 may emit light to notify the backyard of the fact.

When any other state change occurs in the safe device 1, the light-emitting unit 243 may notify the backyard side of that fact by emitting light.

One light-emitting unit 243 is adapted to indicate a plurality of states of the safe device 1. This can be realized, for example, by associating a light emitting pattern with each of a plurality of states and causing one light-emitting unit 243 to emit light in the light emitting pattern corresponding to the state to be notified. However, the present disclosure is not limited to this, and multiple light-emitting units 243 may indicate multiple states of the safe device 1. This can be realized, for example, by associating a light-emitting unit 243 with each of a plurality of states and illuminating the light-emitting unit 243 that corresponds to the state to be notified.

The reading unit 244 reads information from an integrated circuit (IC) card when the IC card is held over it. Alternatively, the reading unit 244 may read information from a smartphone or the like equipped with a FELICA (registered trademark) function when the smartphone or the like is held up. The information thus read is used to authenticate the bank employee when he or she logs in. However, authentication at the time of login may be performed using biometric information read by a biometric information reading unit, or may be performed using an ID and password input from the display operation unit 241.

There is no printer installed in the backyard. This is because there is no demand from the bank for the operation information for the safe device 1 to be printed out on paper to take home. In other words, since the safe device 1 itself is installed in the bank, when the bank side wants to check the operation information, it can directly check the operation information stored in the safe device 1.

### (Functional Configuration of Safe Device)

FIG. 5 is a block diagram showing an example of a functional configuration of the safe device 1. As shown in FIG. 5, the safe device 1 includes a locking/unlocking mechanism 12, a display operation unit 141, a camera 142, a light-emitting unit 143, a reading unit 144, and a printer 145. The safe device 1 also includes a locking/unlocking mechanism 22, a display operation unit 241, a camera 242, a light-emitting unit 243, and a reading unit 244. Furthermore, the safe device 1 includes a control unit 30, a storage unit 40, and a communication unit 50.

The locking/unlocking mechanism 12, display operation unit 141, camera 142, light-emitting unit 143, reading unit 144, printer 145, locking/unlocking mechanism 22, display operation unit 241, camera 242, light-emitting unit 243, and reading unit 244 have already been explained using FIGS. 2 to 4, so explanation will be omitted here.

The control unit 30 includes an arithmetic circuit such as a CPU (Central Processing Unit), and controls each part of the safe device 1 according to an operation program stored in the storage unit 40. In an exemplary implementation, control unit 30 is circuitry. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The storage unit 40 includes a read only memory (ROM), a random access memory (RAM), etc., and stores the operation program for the control unit 30 and is also used as a work area during the control processing of the control unit 30. The operation programs include programs for the control unit 30 to execute the processes described below.

The memory unit 40 also stores storage information regarding the items stored in the safe device 1. Memory unit 40 stores a computer program which includes computer instructions. These computer instructions provide the logic and routines that enable the hardware (e.g., processing circuitry or circuitry of control unit 30) to perform the processes disclosed herein. This computer program can be implemented in formats as a non-transitory computer-readable storage medium, a computer program product, a memory device, a record medium, and/or the memory of a FPGA or ASIC.

Furthermore, the memory unit 40 also stores operation information regarding operations performed by security officers or bank employees on the safe device 1. At this time, the memory unit 40 may store a facial image of the security officer or bank employee in association with the operation content. In this case, the storage unit 40 is an example of a first storage unit that stores the face image of the user captured by the first imaging unit in association with the operation content of the first operation unit by the user. The storage unit 40 is also an example of a second storage unit that stores a face image of the user captured by the second imaging unit in association with the operation content of the second operation unit by the user.

The communication unit 50 communicates information with other devices through a communication line.

Specifically, when a security officer inputs from the display operation unit 141 when retrieving an item that the storage information entered by the bank employee when storing the item is incorrect, the communication unit 50 transmits information to that effect to another device. In addition, when a bank employee inputs from the display operation unit 241 when retrieving an item that the storage information entered by the security officer when storing the item is incorrect, the communication unit 50 transmits information to that effect to another device. In this case, the communication unit 50 is an example of a notification unit that notifies information that inconsistency information has been input by operating the second operation unit.

In addition, when multiple safe devices 1 are installed at one branch office, the communication unit 50 may be used to synchronize the device status and setting information by transmitting and receiving device status and setting information between these multiple safe devices 1.

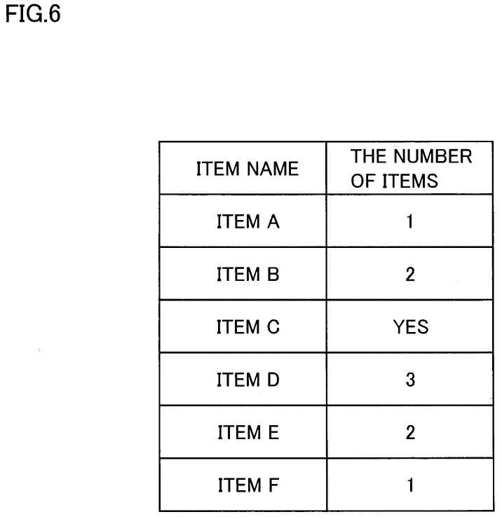

FIG. 6 is a diagram showing storage information stored in the storage unit 40. As shown in FIG. 6, the storage information associates the item name with the number of items.

The item name is the name of the item stored in the safe device 1.

The number is the number of items stored in the safe device 1. However, the quantity can also be set to “Yes.” This is based on the assumption that among items, the presence or absence of some items is more important than the quantity, and that messages other than items may also be exchanged through the safe device 1.

Here, it is shown that there is one item A, two items B, and an item C, etc.

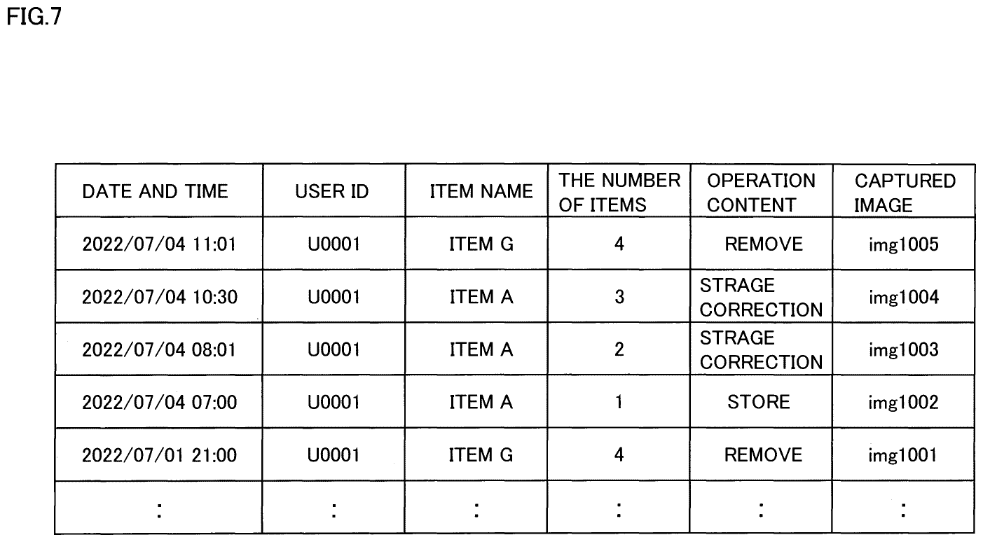

FIG. 7 is a diagram showing operation information stored in the storage unit 40. As shown in FIG. 7, the operation information associates a date and time, a user ID, an item name, a quantity, an operation content, and a captured image.

The date and time are the date and time when the operation was performed.

The user ID is identification information of the user who performed the operation, i.e., the security officer or bank employee. Normally, operation information of multiple users is stored together, but here, only the operation information of the user with user ID “U0001” is extracted and shown.

The item name is the name of the item that is the target of the operation.

The number is the number of items that are the subject of an operation.

The operation content is the content of the operation.

The captured image is an image of the security officer or bank employee who performed the operation.

Here, it is shown that at 11:01 on Jul. 4, 2022, a user with user ID “U0001” took out four items G, and that the captured image of that user was saved as “img1005.”

### (Operation of Safe Device)

First, the operation when a security officer or bank employee successfully logs in will be described. When the security officer successfully logs in on the display operation unit 141, the safe device 1 displays a menu screen on the display operation unit 141. In addition, when the bank clerk successfully logs in on the display operation unit 241, the safe device 1 displays a menu screen on the display operation unit 241.

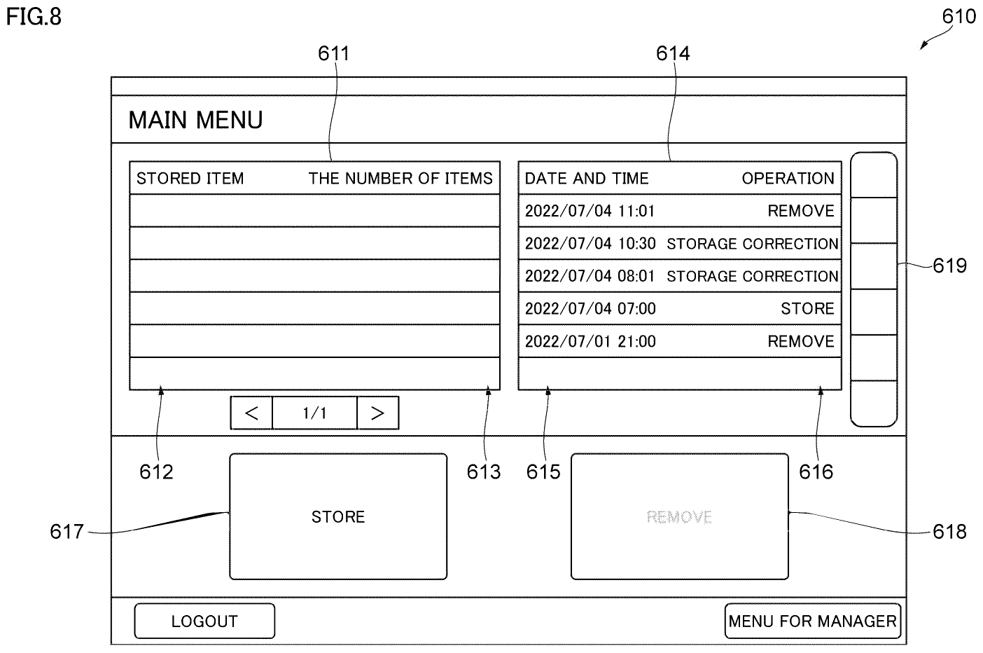

FIG. 8 shows a menu screen 610 that is displayed when there is no item stored in the safe device 1. The same menu screen 610 is displayed on both the display operation unit 141 and the display operation unit 241. As shown in FIG. 8, the menu screen 610 includes a storage information display area 611, an operation information display area 614, a storage button 617, a removal button 618, and a notification icon 619.

The storage information display area 611 is an area for displaying storage information regarding items stored in the safe device 1, and includes an item name display field 612 and an item number display field 613. However, since there is no stored item in the safe device 1 here, the stored item information display area 611 is blank.

The operation information display area 614 is an area for displaying operation information related to operations performed by a security officer or a bank employee on the safe device 1, and includes a date and time display field 615 and an operation content display field 616. In the operation information display area 614, the date and time and operation content of the most recent pieces of operation information among the operation information stored in the storage unit 40 are displayed.

The storage button 617 is pressed when a security officer or bank employee stores an item.

The remove button 618 is pressed when a security officer or a bank employee removes an item. However, since there is no stored item in the safe device 1 at this time, the removal button 618 is grayed out and cannot be pressed.

The notification icon 619 is an icon that notifies the user when an abnormality occurs in the safe device 1 or when the locking/unlocking mechanism 12 or the locking/unlocking mechanism 22 is unlocked in an emergency.

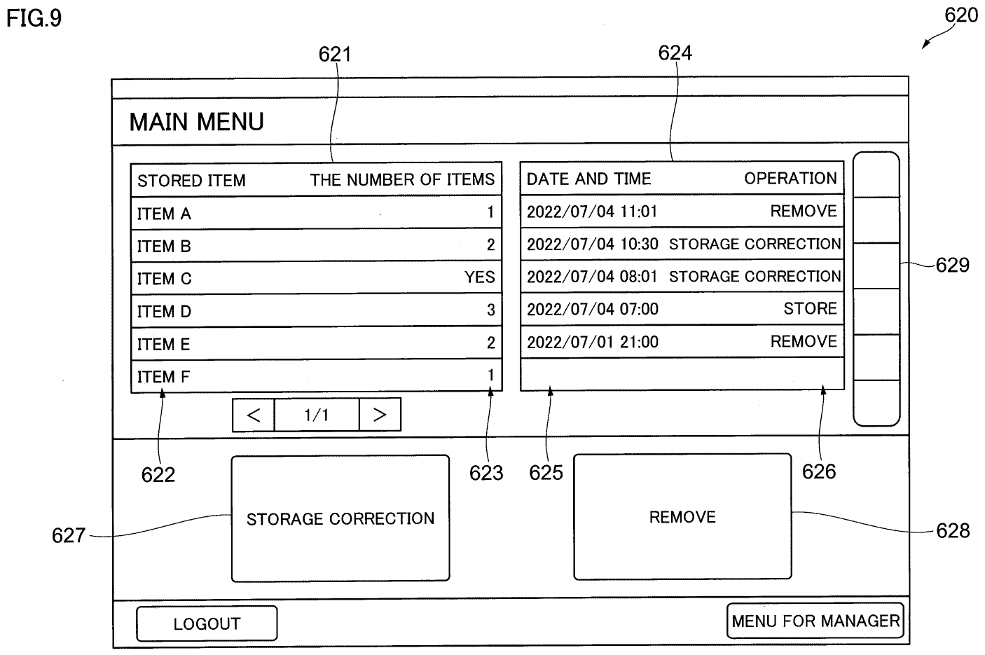

FIG. 9 shows a menu screen 620 that is displayed when there is an item stored in the safe device 1. As shown in FIG. 9, the same menu screen 620 is displayed on both the display operation unit 141 and the display operation unit 241. As shown in FIG. 9, the menu screen 620 includes a storage information display area 621, an operation information display area 624, a storage correction button 627, a removal button 628, and a notification icon 629.

The storage information display area 621 is the same as the storage information display area 611 in FIG. 9. However, since there is an item stored in the safe device 1, the storage information display area 621 is not blank, and the storage information stored in the memory unit 40 is displayed.

The operation information display area 624 is the same as the operation information display area 614 in FIG. 9.

The storage correction button 627 is pressed when a security officer or bank employee wants to correct the storage information that he or she entered when storing an item.

The remove button 628 is pressed when a security officer or bank employee removes an item.

The notification icon 629 is the same as the notification icon 619 of FIG. 9.

Next, the operation when a security officer or a bank employee presses the storage button 617 on the menu screen 610 will be described. When the security officer presses the storage button 617 on the menu screen 610 displayed on the display operation unit 141, the safe device 1 unlocks the door 11 and then displays a storage screen 630 on the display operation unit 141. Furthermore, when the bank clerk presses the storage button 617 on the menu screen 610 displayed on the display operation unit 241, the safe device 1 unlocks the door 21 and then displays a storage screen 630 on the display operation unit 241.

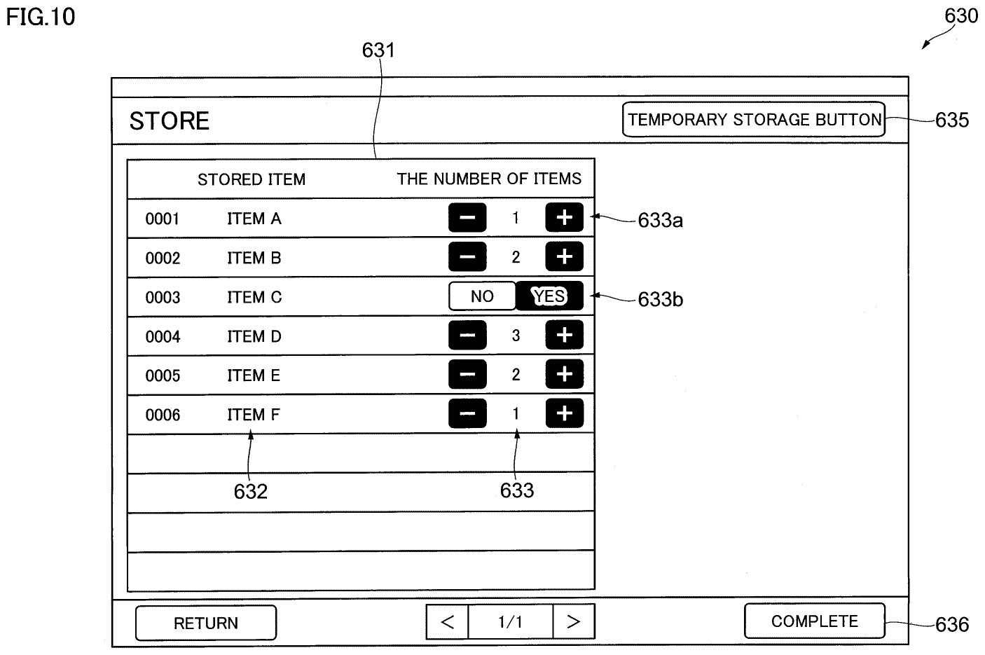

FIG. 10 is a diagram showing the storage screen 630. As shown in FIG. 10, the storage screen 630 includes a storage information input area 631, a temporary storage button 635, and a complete button 636.

The storage information input area 631 is an area for inputting storage information regarding items to be stored in the safe device 1, and includes an item name input field 632 and an item quantity input field 633. The security officer or bank employee inputs the name of the item in the item name input field 632 by selecting from among the item names registered in advance. Further, the input mode in the quantity input field 633 includes an input mode using a set consisting of a quantity, a plus button, and a minus button (for example, set 633a), and an input mode using a set consisting of a yes button and a no button (for example, set 633b). In the former input mode, the security officer or bank employee inputs the determined number by increasing the number with the plus button or decreasing the number with the minus button. In the latter input mode, the security officer or bank employee inputs “Yes” by pressing the Yes button. This is based on the assumption that there may be items stored in the safe device 1 whose presence or absence is more important than the quantity, and that the safe device 1 may also be used to notify of messages other than items. The notification items include, for example, whether or not express delivery is desired. For example, a line “0007” can be added next to the line “0006” in the storage information input area 631, “Express delivery preferred?” can be entered in the item name input field 632, and “Yes” can be entered in the quantity input field 633 by selecting the Yes button between the Yes and No buttons. In this case, this line is a message requesting that all of items A through F be delivered by express mail.

The temporary storage button 635 is pressed when a security officer or a bank employee enters an item name other than the previously registered item names. For example, when the temporary storage button 635 is pressed, the safe device 1 displays a temporary storage screen, and when a security officer or bank employee enters the name of an item in free text on this temporary storage screen, the entered item name is displayed in the item name input field 632. Note that item names other than the pre-registered item names may be entered as free text in the bottom line of the item name input field 632 on the storage screen 630. However, if the number of types of items to be stored increases, the amount of operation required to scroll to the bottom line of the item name input field 632 increases, so here the items are input from the temporary storage screen.

The completion button 636 is pressed when the transport officer or bank employee confirms the items to be stored.

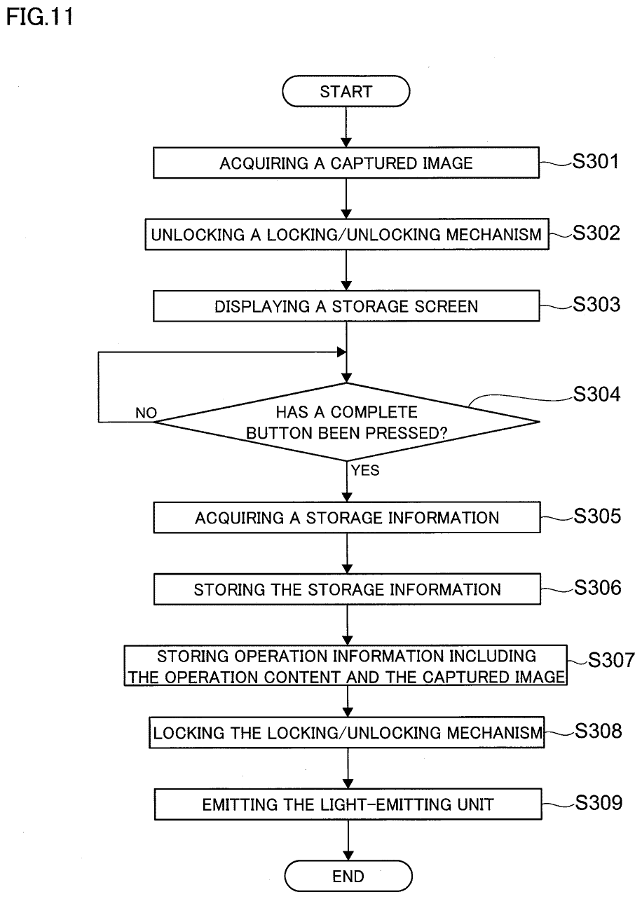

FIG. 11 is a flow chart showing an example of the operation of the safe device 1 in this case.

As shown in FIG. 11, when a security officer or a bank employee presses the storage button 617 on the menu screen 610, the safe device 1 acquires a captured image of the security officer or the bank employee who pressed the storage button 617 (step 301). Specifically, when the security guard presses the storage button 617 on the menu screen 610 displayed on the display operation unit 141, the safe device 1 captures an image of the security guard with the camera 142 and obtains the captured image of the security guard. Furthermore, when the bank clerk presses the storage button 617 on the menu screen 610 displayed on the display operation unit 241, the safe device 1 captures an image of the bank clerk with the camera 242 and obtains the captured image of the bank clerk.

Next, the safe device 1 unlocks the locking/unlocking mechanism 12 or the locking/unlocking mechanism 22 (step 302). Specifically, when the security officer presses the storage button 617 on the menu screen 610 displayed on the display operation unit 141, the safe device 1 unlocks the locking/unlocking mechanism 12. This allows the security officer to open the door 11 and store the items. In addition, when the bank clerk presses the storage button 617 on the menu screen 610 displayed on the display operation unit 241, the safe device 1 unlocks the locking/unlocking mechanism 22. This allows the bank clerk to open the door 21 and store the item.

Next, the safe device 1 displays the storage screen 630 on the display operation unit 141 or the display operation unit 241 (step 303). Specifically, when the security officer presses the storage button 617 on the menu screen 610 displayed on the display operation unit 141, the safe device 1 displays a storage screen 630 on the display operation unit 141. This allows the security officer to input storage information regarding the stored items. In addition, when the bank clerk presses the storage button 617 on the menu screen 610 displayed on the display operation unit 241, the safe device 1 displays a storage screen 630 on the display operation unit 241. This allows the bank clerk to input storage information regarding the stored items.

Next, the safe device 1 judges whether or not the Complete button 636 on the storage screen 630 displayed in step 303 has been pressed (step 304). Specifically, the safe device 1 determines whether or not the Complete button 636 has been pressed on the storage screen 630 displayed on the display operation unit 141. The safe device 1 also determines whether or not the Complete button 636 has been pressed on the storage screen 630 displayed on the display operation unit 241.

If the complete button 636 on the storage screen 630 is not pressed, the safe device 1 repeats the process of step 304.

When the complete button 636 is pressed on the storage screen 630, the safe device 1 acquires the storage information input on the storage screen 630 displayed in step 303 (step 305). Specifically, when the security officer inputs storage information on the storage screen 630 displayed on the display operation unit 141, the safe device 1 acquires this storage information. In addition, when the bank clerk inputs storage information on the storage screen 630 displayed on the display operation unit 241, the safe device 1 acquires this storage information. Then, the safe device 1 stores the storage information acquired in step 305 in the storage unit 40 (step 306).

Next, the safe device 1 stores operation information including the operation content of the security officer or bank employee and the captured image of the security officer or bank employee acquired in step 301 in the memory unit 40 (step 307). At this time, the safe device 1 may include the item name and number in the storage information acquired in step 304 in the operation information.

Next, the safe device 1 locks the locking/unlocking mechanism 12 or the locking/unlocking mechanism 22 (step 308). Specifically, when the security officer presses the completion button 636 on the storage screen 630 displayed on the display operation unit 141, the safe device 1 locks the locking/unlocking mechanism 12. In addition, when the bank clerk presses the completion button 636 on the storage screen 630 displayed on the display operation unit 241, the safe device 1 locks the locking/unlocking mechanism 22.

Thereafter, the safe device 1 causes the light-emitting unit 143 or the light-emitting unit 243 to emit light (step 309). Specifically, when the security officer presses the completion button 636 on the storage screen 630 displayed on the display operation unit 141, the safe device 1 causes the light-emitting unit 143 to emit light. In addition, when the bank clerk presses the completion button 636 on the storage screen 630 displayed on the display operation unit 241, the safe device 1 causes the light-emitting unit 243 to emit light. At this time, the safe device 1 may cause the light-emitting unit to emit light in any manner as long as the manner indicates that an item is present within the safe device 1. For example, the safe device 1 may cause one light-emitting unit to emit light in a light-emitting pattern indicating that an item is present within the safe device 1. Alternatively, the safe device 1 may illuminate one of the multiple light-emitting elements to indicate that an item is present inside the safe device 1.

Next, the operation when a transport officer or a bank employee presses the deposit correction button 627 on the menu screen 620 will be described. When the security officer presses the storage correction button 627 on the menu screen 620 displayed on the display operation unit 141, the safe device 1 unlocks the door 11 and then displays a storage correction screen 640 on the display operation unit 141. In addition, when the bank clerk presses the storage correction button 627 on the menu screen 620 displayed on the display operation unit 241, the safe device 1 unlocks the door 21 and then displays the storage correction screen 640 on the display operation unit 241.

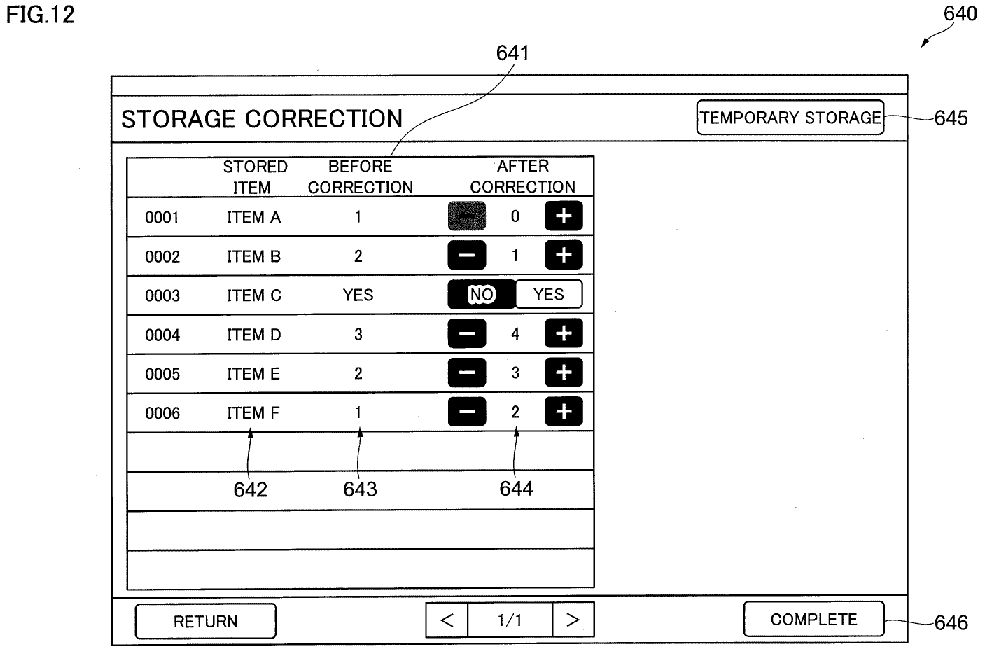

FIG. 12 is a diagram showing a storage correction screen 640. As shown in FIG. 12, the storage correction screen 640 includes a storage correction information input area 641, a temporary correction button 645, and a complete button 646.

The storage correction information input area 641 is an area for inputting storage correction information to correct the storage information entered on the storage screen 630, and includes an item name input field 642, a quantity before correction display field 643, and a quantity after correction input field 644. The item name input field 642 displays the item name input on the storage screen 630. In addition, the number of items input on the storage screen 630 is displayed in the pre-correction number display field 643. Furthermore, in the corrected number input field 644, the number after correcting the number input on the storage screen 630 is input. The input manner in the corrected number input field 644 and the reason for providing this input manner are the same as those described with respect to the number input field 633 in FIG. 12.

The temporary correction button 645 is pressed when a security officer or a bank employee inputs an article name other than the pre-registered article names to make a correction. For example, when the temporary correction button 645 is pressed, the safe device 1 displays a temporary correction screen, and when the security officer or bank clerk enters the item name in free text on this temporary correction screen, the entered item name is displayed in the item name input field 642. The reason why the name of an item other than the preregistered item names is input on a separate screen is the same as that described with respect to the temporary storage button 635 in FIG. 12.

The completion button 646 is pressed when the transport officer or bank employee finalizes the collection correction information.

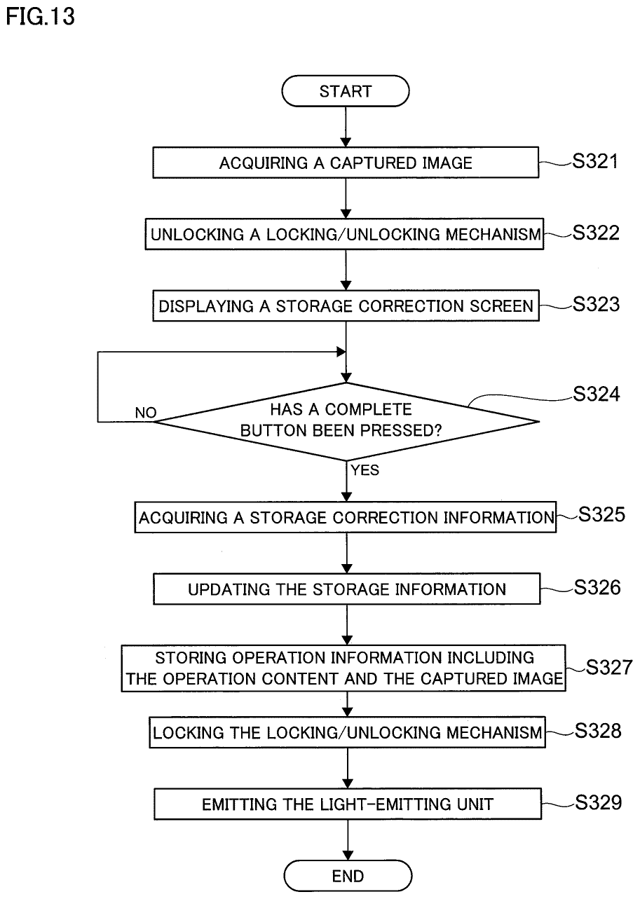

FIG. 13 is a flow chart showing an example of the operation of the safe device 1 in this case.

As shown in FIG. 13, when the transport officer or bank employee presses the storage correction button 627 on the menu screen 620, the safe device 1 acquires a captured image of the transport officer or bank employee who pressed the storage correction button 627 (step 321). Specifically, when the security guard presses the storage correction button 627 on the menu screen 620 displayed on the display operation unit 141, the safe device 1 captures an image of the security guard with the camera 142 and obtains the captured image of the security guard. In addition, when the bank clerk presses the deposit correction button 627 on the menu screen 620 displayed on the display operation unit 241, the safe device 1 captures an image of the bank clerk with the camera 242 and obtains the captured image of the bank clerk.

Next, the safe device 1 unlocks the locking/unlocking mechanism 12 or the locking/unlocking mechanism 22 (step 322). Specifically, when the security officer presses the storage correction button 627 on the menu screen 620 displayed on the display operation unit 141, the safe device 1 unlocks the locking/unlocking mechanism 12. This allows the security officer to open the door 11 and check the stored items. In addition, when the bank clerk presses the deposit correction button 627 on the menu screen 620 displayed on the display operation unit 241, the safe device 1 unlocks the locking/unlocking mechanism 22. This allows a bank employee to open the door 21 and check the stored items.

Next, the safe device 1 displays the storage correction screen 640 on the display operation unit 141 or the display operation unit 241 (step 323). Specifically, when the security officer presses the storage correction button 627 on the menu screen 620 displayed on the display operation unit 141, the safe device 1 displays a storage correction screen 640 on the display operation unit 141. This allows the transport officer to input collection correction information to correct the collection information. In addition, when the bank clerk presses the deposit correction button 627 on the menu screen 620 displayed on the display operation unit 241, the safe device 1 displays a storage correction screen 640 on the display operation unit 241. This enables the bank clerk to input deposit correction information to correct the storage information.

Next, the safe device 1 judges whether or not the Complete button 646 has been pressed on the storage correction screen 640 displayed in step 323 (step 324). Specifically, the safe device 1 judges whether or not the completion button 646 has been pressed on the storage correction screen 640 displayed on the display operation unit 141. The safe device 1 also determines whether or not the Complete button 646 has been pressed on the storage correction screen 640 displayed on the display operation unit 241.

If the complete button 646 on the storage correction screen 640 is not pressed, the safe device 1 repeats the process of step 324.

When the completion button 646 is pressed on the storage correction screen 640, the safe device 1 acquires the storage correction information input on the storage correction screen 640 displayed in step 323 (step 325). Specifically, when the security officer inputs storage correction information on the storage correction screen 640 displayed on the display operation unit 141, the safe device 1 acquires this storage correction information. In addition, when the bank clerk inputs the storage correction information on the storage correction screen 640 displayed on the display operation unit 241, the safe device 1 acquires this storage correction information. Then, the safe device 1 updates the storage information stored in the storage unit 40 with the deposit correction information acquired in step 325 (step 326).

Next, the safe device 1 stores operation information including the operation content of the security officer or bank employee and the captured image of the security officer or bank employee acquired in step 321 in the memory unit 40 (step 327). At this time, the safe device 1 may include the item name and number in the storage correction information acquired in step 324 in the operation information.

Next, the safe device 1 locks the locking/unlocking mechanism 12 or the locking/unlocking mechanism 22 (step 328). Specifically, when the security officer presses the completion button 646 on the storage correction screen 640 displayed on the display operation unit 141, the safe device 1 locks the locking/unlocking mechanism 12. In addition, when the bank clerk presses the completion button 646 on the storage correction screen 640 displayed on the display operation unit 241, the safe device 1 locks the locking/unlocking mechanism 22.

Thereafter, the safe device 1 causes the light-emitting unit 143 or the light-emitting unit 243 to emit light (step 329). Specifically, when the security officer presses the completion button 646 on the storage correction screen 640 displayed on the display operation unit 141, the safe device 1 causes the light-emitting unit 143 to emit light. In addition, when the bank clerk presses the completion button 646 on the storage correction screen 640 displayed on the display operation unit 241, the safe device 1 causes the light-emitting unit 243 to emit light. The manner in which the light emitting portion is caused to emit light is the same as that described with respect to step 309 in FIG. 13.

Next, the operation when the transport officer or bank employee presses the take-out button 628 on the menu screen 620 will be described. When the security officer presses the removal button 628 on the menu screen 620 displayed on the display operation unit 141, the safe device 1 unlocks the door 11 and then displays a removal screen 650 on the display operation unit 141. Furthermore, when the bank clerk presses the removal button 628 on the menu screen 620 displayed on the display operation unit 241, the safe device 1 unlocks the door 21 and then displays a removal screen 650 on the display operation unit 241.

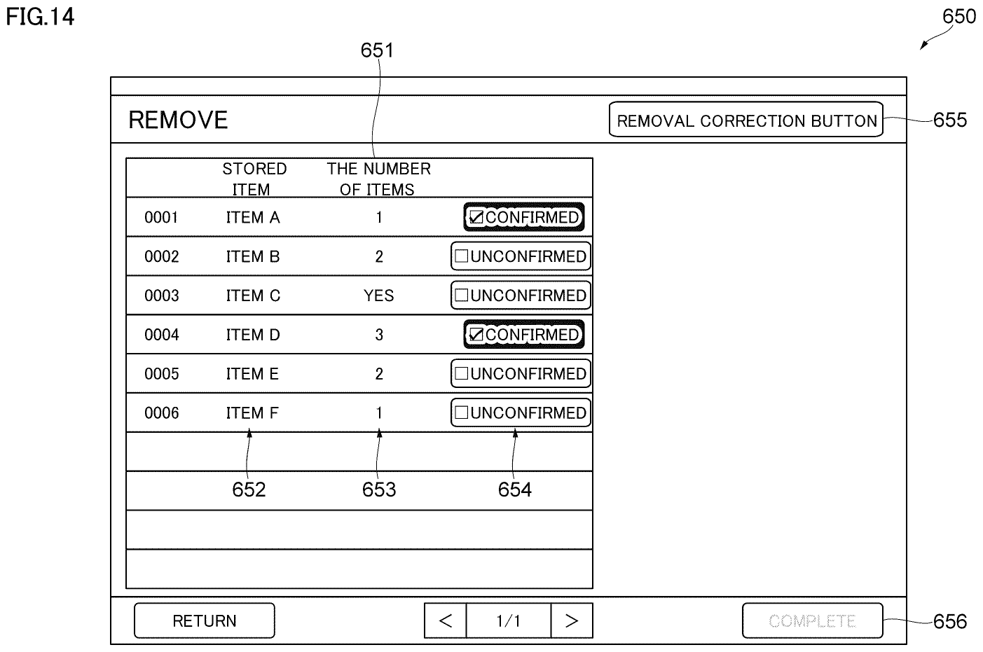

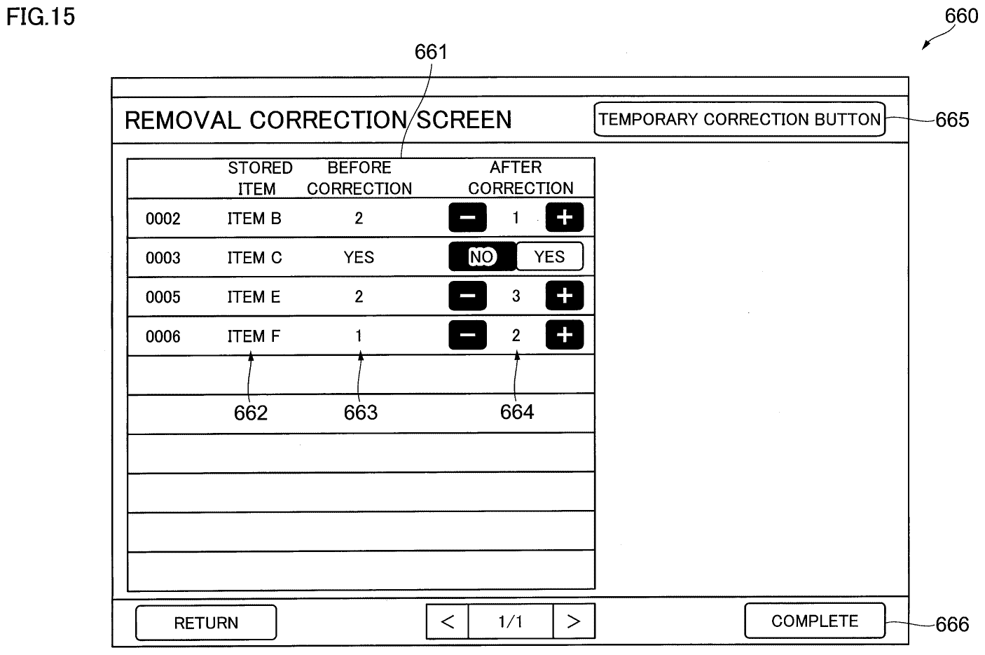

FIG. 14 is a diagram showing the removal screen 650. As shown in FIG. 14, the removal screen 650 includes an extraction information input area 651, a removal correction button 655, and a completion button 656.

The removal information input area 651 is an area for inputting removal information regarding the items to be removed from the safe device 1, and includes an item name display field 652, an item number display field 653, and a confirmation button 654. The item name display field 652 and the number display field 653 display the item name and number included in the storage information stored in the memory unit 40. If the security officer or bank employee sees that the item name displayed in the item name display field 652 and the number displayed in the number display field 653 are the same as the item name and number of items actually removed from the safe device 1, he or she presses the confirmation button 654. Before the confirmation button 654 is pressed, the word “Unconfirmed” is displayed and the checkbox is not checked, but after it is pressed, the word “Confirmed” is displayed and the checkbox is checked.

The removal correction button 655 is a button that is pressed when correcting the name or number of items when the item name displayed in the item name display field 652 or the number displayed in the quantity display field 653 differs from the name or number of items actually removed from the safe device 1.

The completion button 656 is pressed when the security officer or bank employee confirms the items that he or she has removed. Here, since the Confirm button 654 has not been pressed, the Complete button 656 is grayed out and cannot be pressed. For example, when storage information is corrected on the removal correction screen 660 (described later) and all of the confirmation buttons 654 are pressed, the completion button 656 is no longer grayed out and can be pressed.

FIG. 15 is a diagram showing a removal correction screen 660. As shown in FIG. 15, the removal correction screen 660 includes an extraction correction information input area 661, a temporary correction button 665, and a complete button 666.

The removal correction information input area 661 is an area for inputting removal correction information to correct the storage information entered on the storage screen 630 at the time of removal, and includes an item name input field 662, a quantity before correction display field 663, and a quantity after correction input field 664. The item name input field 662 displays the names of items that have not been confirmed on the removal screen 650, among the names of items in the storage information stored in the memory unit 40. Furthermore, the pre-correction number display field 663 displays the number of items that are not confirmed on the removal screen 650 out of the numbers in the storage information stored in the memory unit 40. Furthermore, in a post-correction number input field 664, the number after correcting the number displayed in the pre-correction number display field 663 is input. The input manner in the corrected number input field 664 and the reason for providing this input manner are the same as those described with respect to the number input field 633 in FIG. 15.

The temporary correction button 665 is pressed when a security officer or a bank employee inputs an article name other than the pre-registered article names to make a correction. For example, when the temporary correction button 665 is pressed, the safe device 1 displays a temporary correction screen, and when the security officer or bank clerk enters the item name in free text on this temporary correction screen, the entered item name is displayed in the item name input field 662. The reason why the name of an item other than the preregistered item names is input on a separate screen is the same as that described with respect to the temporary storage button 635 in FIG. 15.

The completion button 666 is pressed when the transport officer or bank employee finalizes the removal correction information.

FIGS. 16-1 and 16-2 are flow charts showing an example of the operation of the safe device 1.

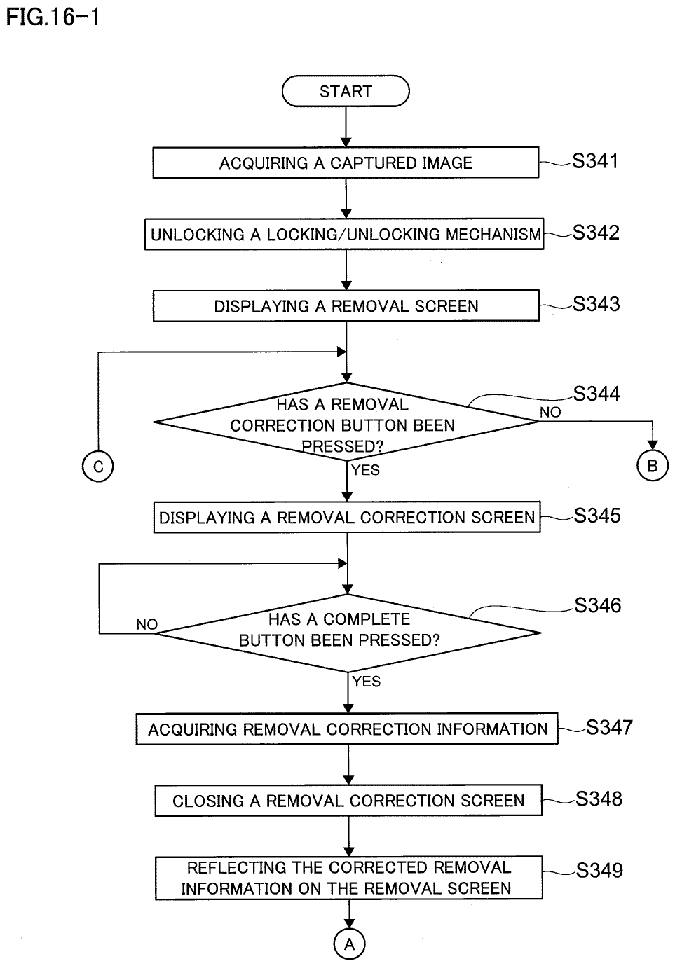

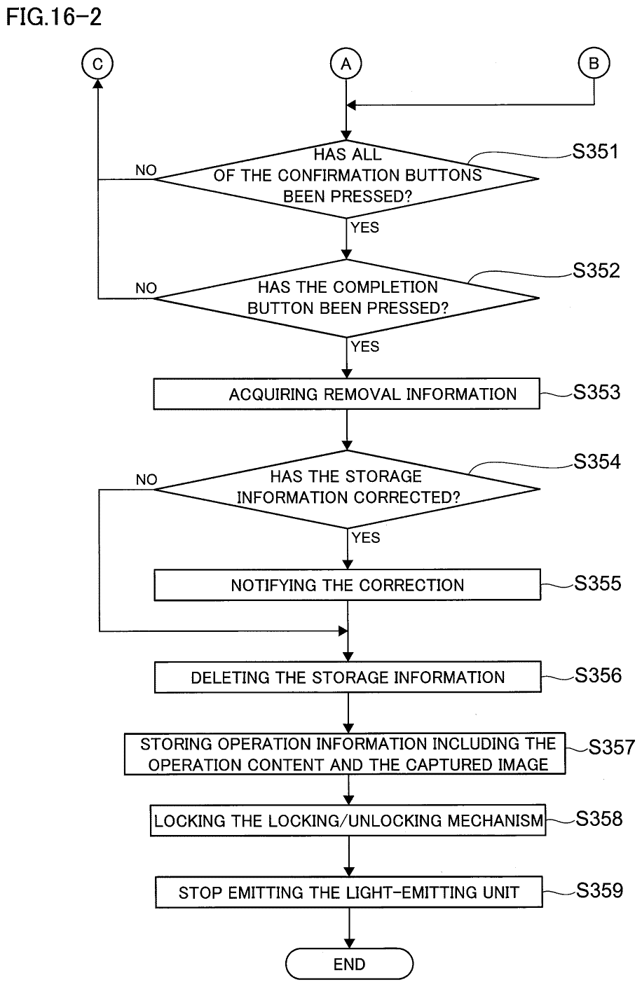

As shown in FIG. 16-1, when the security officer or bank employee presses the take-out button 628 on the menu screen 620, the safe device 1 acquires a captured image of the security officer or bank employee who pressed the take-out button 628 (step 341). Specifically, when the security officer presses the removal button 628 on the menu screen 620 displayed on the display operation unit 141, the safe device 1 captures an image of the security officer with the camera 142 and obtains the captured image of the security officer. Furthermore, when the bank clerk presses the removal button 628 on the menu screen 620 displayed on the display operation unit 241, the safe device 1 captures an image of the bank clerk with the camera 242 and obtains the captured image of the bank clerk.

Next, the safe device 1 unlocks the locking/unlocking mechanism 12 or the locking/unlocking mechanism 22 (step 342). Specifically, when the security officer presses the removal button 628 on the menu screen 620 displayed on the display operation unit 141, the safe device 1 unlocks the locking/unlocking mechanism 12. This allows the security officer to open the door 11 and remove the item. In addition, when the bank clerk presses the removal button 628 on the menu screen 620 displayed on the display operation unit 241, the safe device 1 unlocks the locking/unlocking mechanism 22. This allows the bank clerk to open the door 21 and remove the item.

Next, the safe device 1 displays the removal screen 650 on the display operation unit 141 or the display operation unit 241 (step 343). Specifically, when the security officer presses the removal button 628 on the menu screen 620 displayed on the display operation unit 141, the safe device 1 displays a removal screen 650 on the display operation unit 141. This allows the security officer to input removal information regarding the removed items. Furthermore, when the bank clerk presses the take-out button 628 on the menu screen 620 displayed on the display operation unit 241, the safe device 1 displays a take-out screen 650 on the display operation unit 241. This allows the clerk to input removal information regarding the removed item.

Next, the safe device 1 judges whether or not the removal correction button 655 has been pressed on the withdrawal screen 650 displayed in step 343 (step 344). Specifically, the safe device 1 judges whether or not the removal correction button 655 has been pressed on the removal screen 650 displayed on the display operation unit 141. The safe device 1 also determines whether or not the removal correction button 655 has been pressed on the withdrawal screen 650 displayed on the display operation unit 241.

If the removal correction button 655 on the removal screen 650 has not been pressed, the safe device 1 advances the process to step 351 in FIG. 16-2.

When the removal correction button 655 is pressed on the withdrawal screen 650, the safe device 1 displays a removal correction screen 660 on the display operation unit 141 or the display operation unit 241 (step 345). Specifically, when the security officer presses a removal correction button 655 on the removal screen 650 displayed on the display operation unit 141, the safe device 1 displays a removal correction screen 660 on the display operation unit 141. This allows the security officer to input removal correction information to correct the removal information. In addition, when the bank clerk presses the removal correction button 655 on the withdrawal screen 650 displayed on the display operation unit 241, the safe device 1 displays a removal correction screen 660 on the display operation unit 241. This enables the bank clerk to input removal correction information to correct the withdrawal information.

Next, the safe device 1 judges whether or not the Complete button 666 has been pressed on the removal correction screen 660 displayed in step 345 (step 346). Specifically, the safe device 1 judges whether or not the completion button 666 has been pressed on the removal correction screen 660 displayed on the display operation unit 141. The safe device 1 also determines whether or not the Complete button 666 has been pressed on the removal correction screen 660 displayed on the display operation unit 241.

If the Complete button 666 on the removal correction screen 660 is not pressed, the safe device 1 repeats the process of step 346.

When the completion button 666 is pressed on the removal correction screen 660, the safe device 1 acquires the removal correction information input on the removal correction screen 660 displayed in step 345 (step 347). Specifically, when the security officer inputs removal correction information on the removal correction screen 660 displayed on the display operation unit 141, the safe device 1 acquires this removal correction information. Furthermore, when the bank clerk inputs removal correction information on the removal correction screen 660 displayed on the display operation unit 241, the safe device 1 acquires this removal correction information. Then, the safe device 1 closes the withdrawal correction screen 660 (step 348), and reflects the removal information corrected by the removal correction information acquired in step 347 on the removal screen 650 (step 349).

Next, as shown in FIG. 16B, the safe device 1 judges whether or not all of the confirmation buttons 654 on the removal screen 650 displayed in step 343 have been pressed (step 351). Specifically, the safe device 1 judges whether or not all of the confirmation buttons 654 on the removal screen 650 displayed on the display operation unit 141 have been pressed. The safe device 1 also determines whether or not all of the confirmation buttons 654 on the removal screen 650 displayed on the display operation unit 241 have been pressed.

If not all of the confirmation buttons 654 on the removal screen 650 have been pressed, the safe device 1 returns the process to step 344 in FIG. 16-1.

When all of the confirmation buttons 654 on the removal screen 650 have been pressed, the safe device 1 determines whether or not the completion button 656 has been pressed on the removal screen 650 displayed in step 343 (step 352). Specifically, the safe device 1 determines whether or not the Complete button 656 has been pressed on the removal screen 650 displayed on the display operation unit 141. The safe device 1 also determines whether or not the Complete button 656 has been pressed on the removal screen 650 displayed on the display operation unit 241.

If the Complete button 656 on the removal screen 650 has not been pressed, the safe device 1 returns the process to step 344 in FIG. 16-1.

When the Complete button 656 is pressed on the removal screen 650, the safe device 1 obtains the removal information entered on the removal screen 650 displayed in step 343 or the removal information corrected on the removal correction screen 660 displayed in step 345 (step 353). Specifically, when the security officer inputs removal information on the removal screen 650 displayed on the display operation unit 141, the safe device 1 acquires this removal information. When the security officer inputs removal correction information on the removal correction screen 660 displayed on the display operation unit 141, the safe device 1 acquires the removal information corrected by this removal correction information. Furthermore, when the bank clerk inputs removal information on the removal screen 650 displayed on the display operation unit 241, the safe device 1 acquires this removal information. When the bank clerk inputs removal correction information on the removal correction screen 660 displayed on the display operation unit 241, the safe device 1 obtains the withdrawal information corrected by this removal correction information.

Next, the safe device 1 judges whether or not the security officer or bank employee has corrected the storage information that was input when the article was stored (step 354). This determination may be made, for example, by comparing the number of items before correction and the number of items after correction on the removal screen 650, or by receiving information from the removal correction screen 660 that the storage information has been corrected.

If the security officer or bank employee has not corrected the storage information entered when the item was stored, the safe device 1 advances the process to step 356. If the security officer or bank employee corrects the storage information that was input when the goods were stored, the safe device 1 notifies an external device to that effect (step 355).

Next, the safe device 1 deletes the storage information stored in the memory unit 40 (step 356). However, as will be described in the next step 357, the safe device 1 keeps the storage information as history.

Next, the safe device 1 stores in the memory unit 40 operation information including the operation content of the security officer or bank employee and the captured image of the security officer or bank employee acquired in step 341 (step 357). At this time, the safe device 1 may include the item name and number in the removal information acquired in step 345 or step 352 in the operation information.

Next, the safe device 1 locks the locking/unlocking mechanism 12 or the locking/unlocking mechanism 22 (step 358). Specifically, when the security officer presses the completion button 656 on the removal screen 650 displayed on the display operation unit 141, the safe device 1 locks the locking/unlocking mechanism 12. In addition, when the bank clerk presses the complete button 656 on the removal screen 650 displayed on the display operation unit 241, the safe device 1 locks the locking/unlocking mechanism 22.

Thereafter, the safe device 1 stops the emission of light from the light-emitting unit 143 or the light-emitting unit 243 (step 359). Specifically, when the security officer presses the completion button 656 on the removal screen 650 displayed on the display operation unit 141, the safe device 1 stops the emission of light from the light-emitting unit 143. In addition, when the bank clerk presses the completion button 656 on the removal screen 650 displayed on the display operation unit 241, the safe device 1 stops the emission of light from the light-emitting unit 243.

### (Modification)

In the above, the removal information that a security officer or bank employee enters when removing an item is information obtained by determining whether the storage information entered when the item was stored is correct, but this is not limited to this. The removal information entered by a security officer or bank employee when removing an item may be the name and number of the items actually removed, regardless of the name and number of the items in the storage information entered when the items were stored.

At that time, the control unit 30 determines whether the item name and quantity in the storage information entered when the items are stored match the item name and quantity in the removal information entered when the items are removed. In this case, the storage information is an example of first information, the removal information is an example of second information, and the control unit 30 is an example of a judgment unit that determines whether the first information and the second information are consistent.

If the item name and number in the storage information do not match the item name and number in the removal information, the control unit 30 may notify this fact. Here, the notification may be performed by displaying on the display operation unit 141 or the display operation unit 241, or may be performed by transmitting to a higher-level device. In this case, the control unit 30 is an example of a notification unit that notifies the user when the determination unit determines that the first information and the second information are not consistent.

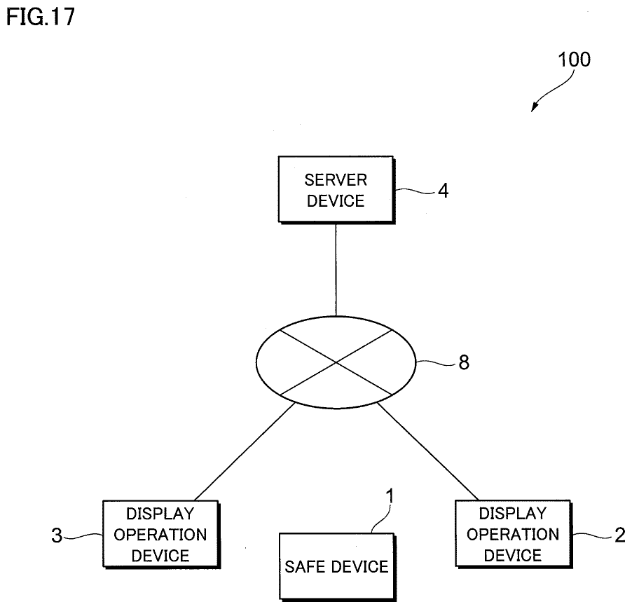

FIG. 17 is a diagram showing an example of the configuration of a safe system 100. As shown in FIG. 17, the safe system 100 includes a safe device 1, a display operation device 2, a display operation device 3, and a server device 4. Of these, the display operation device 2, the display operation device 3, and the server device 4 are connected to each other via a communication line 8.

The safe device 1 in FIG. 17 has a door 11, a locking/unlocking mechanism 12, a locking/unlocking operation unit 13, and an operation terminal 14 on the ATM corner side, and a door 21, a locking/unlocking mechanism 22, a locking/unlocking operation unit 23, and an operation terminal 24 on the backyard side. On the other hand, the safe device 1 does not have the function of accepting storage information, storage correction information, removal information, and removal correction information that the operation terminal 14 and operation terminal 24 had in the safe device 1 in the first embodiment. Furthermore, the safe device 1 does not have the function of storing storage information, which the storage unit 40 has in the safe device 1 of the first embodiment. Safe device 1 is an example of a safe device that includes a first door provided on a first side, which is one of the ATM corner side and the backyard side, and a second door provided on a second side, which is the other of the ATM corner side and the backyard side.

The display operation device 2 has a function of receiving storage information, deposit correction information, withdrawal information, and removal correction information, which are provided by the operation terminal 14 in the safe device 1. The display operation device 2 is a terminal device carried by the security officer, and may be, for example, a smartphone. When a security guard stores items at the ATM corner, the storage information is an example of first information regarding the items to be stored through the first door, and the display operation device 2 is an example of a first operation device that is operated to input the first information. When a security guard removes an item at the ATM corner, the removal information is an example of second information regarding the item to be removed from the second door, and the display operation device 2 is an example of a second operation device that is operated to input the second information.

The display operation device 3 has a function of receiving storage information, storage correction information, removal information, and removal correction information, which are provided by the operation terminal 24 in the safe device 1. The display operation device 3 is a terminal device used by a bank clerk, and may be, for example, a personal computer installed in the bank. When a bank employee stores items in the backyard, the storage information is an example of first information regarding the items stored through the first door, and the display operation device 3 is an example of a first operation device that is operated to input the first information. When a bank employee removes an item in the backyard, the removal information is an example of second information regarding the item to be removed through the second door, and the display operation device 3 is an example of a second operation device that is operated to input the second information.

The server device 4 has a function of storing storage information, which is the function of the storage unit 40 in the safe device 1.

For example, when a security officer inputs storage information into the display operation device 2, the server device 4 receives and stores this storage information, and when a bank clerk inputs removal information into the display operation device 3, the server device 4 receives this removal information. Then, the server device 4 judges whether the storage information and the removal information match, and if they match, deletes the storage information, assuming that the transfer of the goods has been successful, and if they do not match, notifies the user that there has been a problem in the transfer of the goods.

In addition, when a bank clerk inputs storage information to the display operation device 3, the server device 4 receives and stores this storage information, and when a security officer inputs removal information to the display operation device 2, the server device 4 receives this removal information. Then, the server device 4 judges whether the storage information and the removal information match, and if they match, deletes the storage information, assuming that the transfer of the goods has been successful, and if they do not match, notifies the user that there has been a problem in the transfer of the goods.

In some embodiments, the safe device 1 is installed in an empty space of the ATM. This makes it possible to install the safe device 1 in a financial institution without carrying out large-scale construction work. In addition, it also eliminates the need for security guards to enter the branch or for bank employees to have to leave the branch, making it possible to safely exchange goods.

In some embodiments, when an article is taken out, if there is a difference between the article and the article stored in the safe device 1, a notification is given immediately. This makes it possible to clarify the scope of responsibility in the event of a problem with the transfer of goods.

### EXPLANATION OF SYMBOLS

Reference Signs List 1: safe device, 10: ATM corner side housing, 20: backyard side housing, 11, 21: door, 12, 22: locking/unlocking mechanism, 13, 23: locking/unlocking operation unit, 131, 231: key operation unit, 132: numeric keypad, 133: small door, 14, 24: operation terminal, 141, 241: display operation section, 142, 242: camera, 143, 243: light-emitting unit, 144, 244: reading unit, 145: printer, 30: control unit, 40: storage unit, 50: communication unit

1. A safe device, comprising:
a housing installed in contact with a wall of a facility, the housing and the wall separating a first area of the facility from a second area of the facility;
a first door on a first surface of the housing and facing the first area;
a second door on a second surface of the housing and facing the second area;
a first operation interface facing the first area and operated to input first information related to an item inserted into the safe device through the first door; and
a second operation interface facing the second area and operated to input second information related to an item to be removed from the safe device through the second door.

2. The safe device according to claim 1, wherein the second operation interface receives, as the second information, consistency determination information indicating whether the first information and the item to be removed from the second door are consistent.

3. The safe device according to claim 2, wherein the second operation interface receives, as the consistency determination information, consistency information indicating that the first information and the item to be removed from the second door are consistent.

4. The safe device according to claim 2, wherein the second operation interface receives, as the consistency determination information, inconsistency information indicating that the first information and the item to be removed from the second door are not consistent.

5. The safe device according to claim 4, wherein the second operation interface receives, as the inconsistency information, information obtained by correcting the first information so as to match the item to be removed from the second door.

6. The safe device according to claim 4, further comprising a display that displays information that the inconsistency information has been input by operating the second operation interface.

7. The safe device according to claim 1, further comprising circuitry configured to determine whether the first information and the second information are consistent.

8. The safe device according to claim 7, further comprising a display that displays, when the circuitry determines that the first information and the second information do not match, an indication that the first information and the second information do not match.

9. The safe device according to claim 1, wherein the first operation interface is operated to input information after correcting the first information so as to match the item inserted into the safe device through the first door.

10. The safe device according to claim 1, further comprising a display facing one of the first area and the second area, the display outputting information indicating that one of the first operation interface and the second operating interface is being operated.

11. The safe device according to claim 1, further comprising a display facing one of the first area and the second area, the display outputting information indicating that one of the first door and the second door is open.

12. The safe device according to claim 1, further comprising:
a camera facing the first area; and
a storage that stores a face image of a user captured by the camera in association with an operation of the first operation interface by the user.

13. The safe device of claim 1 further comprising:
a camera facing the second area;
a storage that stores a face image of the user captured by the camera in association with an operation of the second operation interface by the user.

14. The safe device according to claim 1, further comprising a printer facing the first area and which prints operation information of the first operation interface.

15. The safe device according to claim 1, further comprising:
a first locking/unlocking mechanism that locks and unlocks the first door; and
a second locking/unlocking mechanism that locks and unlocks the second door.

16. The safe device according to claim 15, further comprising:
a first emergency unlocking operation unit that is operated to perform unlocking by the first locking/unlocking mechanism with mechanical operation in an emergency;
a second emergency unlocking operation unit that is operated to perform unlocking by the second locking/unlocking mechanism with mechanical operation in an emergency; and
a third emergency unlocking operation unit that is operated to perform unlocking of one of the first locking/unlocking mechanism and the second locking/unlocking mechanism by a key input signal in an emergency.

17. The safe device according to claim 15, further comprising:
a first emergency unlocking operation unit that is operated to perform unlocking by the first locking/unlocking mechanism with mechanical operation in an emergency;
a second emergency unlocking operation unit that is operated to perform unlocking by the second locking/unlocking mechanism with mechanical operation in an emergency; and
an emergency door which covers the first emergency unlocking operation unit.

18. The safe device according to claim 15, wherein
the first locking/unlocking mechanism and the second locking/unlocking mechanism operate exclusively with each other, and
the first door and the second door are operable such that when one of the first door and the second door is open, the other of the first door and the second door cannot be opened.

19. A safe system, comprising:
a housing installed in contact with a wall of a facility, the housing and the wall separating a first area of the facility from a second area of the facility;
a safe device including:
a first door on a first surface of the housing and facing the first area; and
a second door on a second surface of the housing and facing the second area;
a first operation interface facing the first area and that is operated to input first information related to an item inserted into the safe device through the first door, and
a second operation interface facing the second area and that is operated to input second information related to an item to be removed from the safe device through the second door.
